(19) United States
(12) Patent Application Publication
(10) Pub. No.: US 2015/0155720 A1
(43) Pub. Date: Jun. 4, 2015

(54) CHARGE-DISCHARGE CONTROLLER, SYSTEM AND METHOD

(71) Applicant: Denso Corporation, Kariya-city (JP)

(72) Inventors: Atsushi MISE, Nagoya-city (JP); Shizuo TSUCHIYA, Gifu-city (JP)

(21) Appl. No.: 14/555,766

(22) Filed: Nov. 28, 2014

(30) Foreign Application Priority Data
Nov. 29, 2013 (JP) 2013-247324

(51) Int. Cl. H02J 7/00; H01M 10/44

(52) U.S. Cl. CPC H02J 7/0013; H01M 10/441; H02J 7/007

(57) ABSTRACT

A charge-discharge system includes a consolidation ECU and a plurality of storage batteries having equal rated capacities for charging electric power from a power grid and for discharging electric power stored therein. The consolidation ECU is configured to perform a charge operation or a discharge operation exclusively on only one of the plurality of storage batteries at a time, according to a priority order of each of the plurality of storage batteries, without performing a charge operation or a discharge operation on more than one of the plurality of storage batteries simultaneously. In such manner, in a system having a plurality of storage batteries having equal rated capacities, drastic fluctuation of charge/discharge electric power is prevented.

### CROSS REFERENCE TO RELATED APPLICATION

The present application is based on and claims the benefit of priority of Japanese Patent Application No. 2013-247324, filed on Nov. 29, 2013, the disclosure of which is incorporated herein by reference.

### TECHNICAL FIELD

The present disclosure generally relates to a charge-discharge controller, system and method for charging electric power from a power grid to an electricity storage device and discharging the stored electric power from the electricity storage device.

### BACKGROUND INFORMATION

A patent document 1 (i.e., Japanese Patent Laid-Open No. 2013-192327) discloses a storage battery controller. The controller in the patent document 1 determines a priority order for discharging each of multiple sets of the storage batteries based on parameters obtained from each of the storage batteries. Then, based on the determined discharge order, the controller sets an output amount of a discharge electric power to each of the electricity storage devices in order to supply a required power for outputting in response to the demand from the outside of the controller.

According to the controller in the above-mentioned patent document 1, in order to discharge the required power based on the determined priority order, several sets of the storage batteries, from which electric discharge is performed, are selected from among the entire group of batteries in a system. Accordingly, electric discharge from two or more storage batteries may be carried out simultaneously.

Thus, in a system that performs simultaneous electric discharge from multiple storage batteries, an output amount of the electric power outputted from the storage batteries may change drastically from time to time (i.e., at every discharge occasion) in response to the discharge demand.

When the output amount of the electric power changes drastically from time to time (i.e., every time the required electric power is discharged from the storage batteries), an overcurrent protection value that protects the storage battery of the system from an over-current may not function effectively, thereby, not effectively protecting the storage batteries.

For example, when one of the multiple storage batteries has an instantaneous output capacity of 5 kW and another one of the multiple batteries has an instantaneous output capacity of 1 kW, the overcurrent protection value of a circuit breaker is set up based on discharging at 5 kW.

In such a setup, when the required power for discharging is 5 kW and the required power is discharged from the storage battery having the instantaneous output capacity of 5 kW, an over-current is prevented from flowing to the 5 kW storage battery with the above-described setup of the overcurrent protection value.

On the other hand, when the required power of discharge is 6 kW, in addition to the discharge from the storage battery of 5 kW, the required power may be discharged not only from the 5 kW storage battery but also from the storage battery having the instantaneous output capacity of 1 kW. In this case, even if an electric current of such discharge may not be an over-current for the 5 kW storage battery, the same electric current of such discharge may be an over-current for the 1 kW storage battery. In other words, the overcurrent protection value set up to protect the storage battery with the 5 kW instantaneous output capacity may not protect over-current from flowing to the 1 kW storage battery.

### SUMMARY

It is an object of the present disclosure to provide a charge-discharge controller and a charge-discharge system which is capable of maintaining the fluctuation of the charge power and discharge power when the electric power is charged to and discharged from the multiple storage batteries respectively having the rated capacities of similar levels.

For achieving the above-described object, the following technique is presented. The numerals in the Claims and in the description of this Summary section indicate a relationship between the claimed elements and the concrete device described later in the embodiment.

In an aspect of the present disclosure, a charge-discharge controller includes a controller that controls a charge operation of the plurality of storage batteries having equal rated capacities which charges electric power from a power grid to the plurality of storage batteries, and a discharge operation of the plurality of storage batteries which discharges electric power stored in the plurality of storage batteries. The controller performs the charge operation or the discharge operation on only one of the plurality of storage batteries at a time, according to a priority order of the plurality of storage batteries, without performing a charge operation or a discharge operation on more than one of the plurality of storage batteries simultaneously.

Further, what is meant by the plurality of storage batteries respectively having substantially the same rated capacities is that the plurality of storage batteries have substantially the same level of electric power storage capacity. In other words, the plurality of storage batteries controlled by the charge-discharge controller respectively have the same full-charge electric power storage capacities or the capacity difference among those batteries is within a tolerance range of the product (e.g., the capacity difference is within a range of 10% difference or the like).

According to the present disclosure, when the charge-discharge controller charges and discharges the plurality of storage batteries, the controller does not operates/drives two storage batteries at the same time, i.e., the controller drives one battery at a time for charging/discharging according to the priority order. Since each of the plurality of storage batteries has the substantially the same rated capacity, such a charge/discharge control scheme enables a moderate change in the drive of each of the plurality of storage batteries, in which the amount of electric power charged from the power grid to the storage batteries and the amount of electric power discharged from the storage batteries will not change drastically in the course of charge/discharge of those batteries. Therefore, according to the present disclosure about the charge-discharge controller, the charge power and the discharge power for charging and discharging batteries of the substantially the same rated capacity are maintained in a suitable range of the electric power.

In another aspect of the present disclosure, a charge-discharge system includes a plurality of storage batteries having equal rated capacities to charge electric power from and to discharge electric power to a power grid, and a charge-discharge controller that controls a charge operation of the plurality of storage batteries which charges electric power from the power grid to the plurality of storage batteries, and a discharge operation of the plurality of storage batteries that discharges electric power stored in the plurality of storage batteries. The controller performs the charge operation or the discharge operation on only one of the plurality of storage batteries at a time, according to a priority order of the plurality of storage batteries, without performing a charge operation or a discharge operation on more than one of the plurality of storage batteries simultaneously.

In yet another aspect of the present disclosure, a method for controlling charge-discharge to a plurality of storage batteries having equal rated capacities includes controlling a charge operation of the plurality of storage batteries which charges electric power from a power grid to the plurality of storage batteries, and a discharge operation of the plurality of storage batteries which discharges electric power stored in the plurality of storage batteries. The method also includes performing the charge operation or the discharge operation on only one of the plurality of storage batteries at a time, according to a priority order of the plurality of storage batteries, without performing a charge operation or a discharge operation on more than one of the plurality of storage batteries simultaneously.

According to the present disclosure, when the charge-discharge system charges and discharges the plurality of storage batteries of substantially the same rated capacities, the system does not drive two storage batteries at the same time, i.e., the system drives one battery at a time for charging/discharging according to the priority order. Since each of the plurality of storage batteries has the same-level rated capacity, such a charge/discharge control scheme enables a moderate change in the drive of each of the plurality of storage batteries, in which the amount of electric power charged from the power grid to the storage batteries and the amount of electric power discharged from the storage batteries will not change drastically because the amount of the charge/discharge electric power is always regulated/limited to the amount of charge/discharge of only one battery. Therefore, according to the present disclosure about the charge-discharge system, the charge power and the discharge power for charging and discharging batteries of the same-level rated capacity are maintained in a suitable range of the electric power.

### BRIEF DESCRIPTION OF THE DRAWINGS

Objects, features, and advantages of the present disclosure will become more apparent from the following detailed description made with reference to the accompanying drawings, in which:

FIG. 1 is a block diagram of a charge-discharge system of the present disclosure;

FIG. 2 is a flowchart of a charge operation of the charge-discharge system of the present disclosure;

FIG. 3 is a flowchart of a discharge operation of the charge-discharge system of the present disclosure;

FIG. 4 is a flowchart of the charge operation of the charge-discharge system of the present disclosure; and

FIG. 5 is a flowchart of the discharge operation of the charge-discharge system of the present disclosure.

### DETAILED DESCRIPTION

In the following, multiple embodiments for carrying out the present disclosure are explained, with reference to the drawings. In each of the multiple embodiments, already described matters in the preceding embodiments may be not repeated, by simply using the same reference numerals. When a part of the configuration is described in an embodiment, other parts of the configuration may be borrowed from the preceding one. Further, not only the explicitly described combination of two or more embodiments or two or more parts thereof but other combination of the embodiments or the parts thereof should also be allowed unless otherwise designated.

### First Embodiment

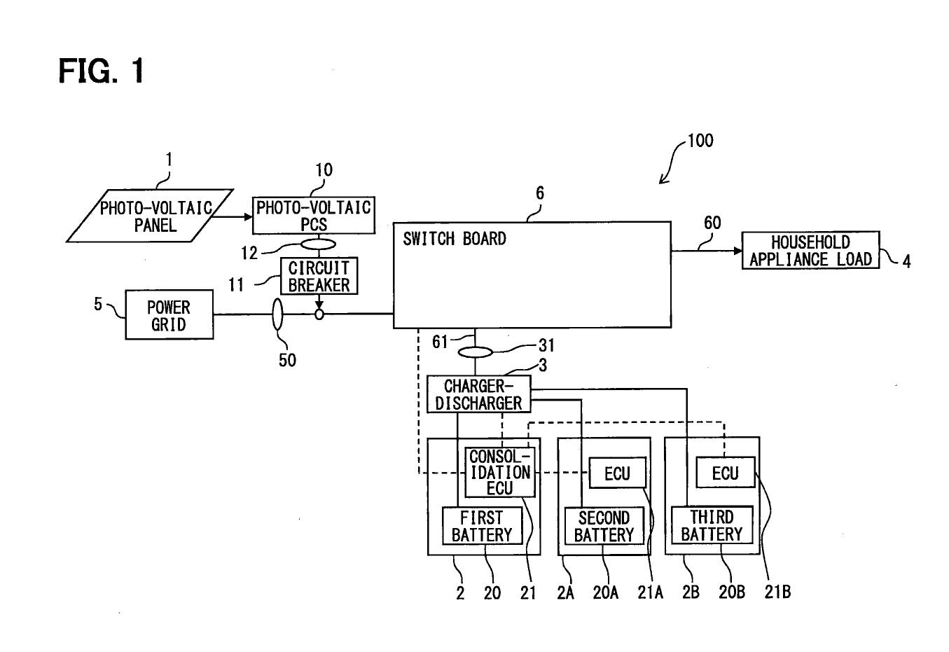

A charge-discharge system provided with a charge-discharge controller as an example of this invention and is explained. As shown in FIG. 1, a charge-discharge system 100 is provided with multiple electricity storage devices and a consolidation ECU 21 which is a charge-discharge controller of the multiple electricity storage devices. The consolidation ECU 21 is an ECU which is capable of controlling various devices of the charge-discharge system 100. The consolidation ECU 21 may be disposed in an inside of an operation display device which accepts an input of a user operation from the user. The operation display device is a device with which an operating state of the charge-discharge system 100 is displayed, and, for example, is a remote operation terminal allocated in the building of a residence.

The charge-discharge system 100 may be configured so that it further includes a photovoltaic power generation apparatus which is, for example, a power generator generating electricity using energy of nature. The photovoltaic power generation apparatus is configured to be capable of supplying the generated electric power to the multiple electricity storage devices. The charge-discharge system 100 may be configured so that it further includes a switch board 6 installed in the building which may be a residence, for example, and a household appliance load 4 is connected thereto by a power line 60 that extends from the switch board 6. The household appliance load 4 may be a lighting device, a home electric apparatus, a water heat, an air-conditioner, a floor heating appliance, etc., for example.

The multiple electricity storage devices controlled by the consolidation ECU 21 are charged with the electric power (i.e., a commercial electric power) supplied from a power grid 5. The multiple electricity storage devices also can charge/store the generated electric power of the photovoltaic power generation apparatus. The multiple electricity storage devices can discharge the stored electric power stored therein to, for example, a utility company through the power grid 5, or they can supply the stored electric power to the household appliance load 4. The multiple electricity storage devices respectively have the charge priority order and the discharge priority order assigned thereto, for the charging and discharging of electric power to/from each of the multiple electricity storage devices. The multiple electricity storage devices may more practically be three devices, i.e., electricity storage devices 2 and 2A and 2B as illustrated in FIG. 1, for example.

The electricity storage device 2 is provided with the consolidation ECU 21 and a first battery 20, which can charge and discharge electric power. The electricity storage device 2A is provided with an ECU 21A and a second battery 20A which can charge and discharge electric power. The electricity storage device 2B is provided with an ECU 21 B and a third battery 20B, which can charge and discharge electric power. The ECU 21A is configured to be communicable with the consolidation ECU 21, and provides the consolidation ECU 21 with battery information, e.g., a voltage, an electric current, temperature, and SOC (i.e., State Of Charge, an amount of electric power stored therein) of the second battery 20A, and receives variety of information from the consolidation ECU 21. The ECU 21B is configured to be communicable with the consolidation ECU 21, and provides the consolidation ECU 21 with battery information, e.g., a voltage, an electric current, temperature, and SOC of the third battery 20B, and receives variety of information from the consolidation ECU 21.

The electricity storage device 2 may also be designated as a master device, since it has the consolidation ECU 21 which controls a charge operation and a discharge operation of the multiple electricity storage devices. Since the electricity storage devices 2A and 2B are controlled by the consolidation ECU 21 in the master device, they may also be designated respectively as a slave device.

The first battery 20, the second battery 20A, and the third battery 20B respectively have a rated capacity comparable to each other. Here, the comparable rated capacity of each of the three batteries 20, 20A, 20B may be a capacity for storing electric power by an amount of the same level among them. That is, in other words, the electric power storage capacity of each of the multiple electricity storage devices 2 and 2A and 2B at a full charge time is set to the same value, or is set to the same “level/range”, or the measured value of electric power storage capacity of each of the storage devices is within a product tolerance range. Thus, the electric power storage capacity at the full charge time of each of the electricity storage devices is the same, or the difference of such capacity among these devices should be set, for example, to be less than 10% of the full charge storage capacity. For example, the actual measurement values of the full charge capacity of each of three electricity storage devices may be set to have a less-than 10% difference from each other, which may be 5.0 kW, 5.2 kW, and 4.8 kW in numbers.

Batteries in the present embodiment may be, for example, a household battery or a vehicle battery. Batteries are, for example, more practically a set of battery cells that combines multiple secondary batteries such as a nickel-hydride battery, a lithium-ion battery, and the like. The household battery is an electricity storage device having a stationary type rechargeable battery which is fixed to a building, or to the ground, etc., and is a rechargeable battery with a large electricity storage capacity stationed in the building, and can supply electric power to the household appliance load 4, or to a vehicle battery, etc. The vehicle battery is a rechargeable battery with a large storage capacity installed in vehicles. The vehicles may be, for example, a plug-in hybrid vehicle, an electric vehicle or the like.

The consolidation ECU 21 obtains battery information (e.g., information on each of the first battery 20, the second battery 20A, and the third battery 20B), such as a voltage, an electric current, a battery temperature, an SOC and the like. The consolidation ECU 21 is a controller that is capable of controlling the operation of the charger-discharger 3, the switch board 6 and the like. The consolidation ECU 21 can perform a charge operation (i.e., a charge operation) and a discharge operation (i.e., a discharge operation) by controlling the charger-discharger 3 to charge/discharge each of the first battery 20, the second battery 20A, and the third battery 20B.

The consolidation ECU 21 is provided with a memory unit, a priority determination unit, and a drive controller. The memory unit comprises memories (e.g., ROM and RAM) and memorizes a discharge priority determination criteria and a charge priority determination criteria in advance, buying price information about buying electric power from the power grid 5, selling price information about selling electric power to the power grid 5, etc. The buying price information and the selling price information, etc. may be information inputted periodically or irregularly to the memory unit. Further, the memory unit may memorize battery states concerning each of the electricity storage devices, e.g., the SOC, the battery temperature, the voltage, the electric current and the like. The battery state may be utilized by the priority determination unit for determining the charge priority determination criteria and the discharge priority determination criteria.

The priority determination unit determines a charge/discharge priority order according to the discharge priority determination criteria and the charge priority determination criteria which are memorized in advance by the memory unit. Further, the priority determination unit periodically updates the priority order by performing an arithmetic operation of the pre-memorized program with a supply of the information on a degree of use of each of the electricity storage devices, for example, a charge time/hour, a discharge time/hour, a number of charge times, and a number of discharge times. The information about the degree of use of each of the electricity storage devices may be memorized and updated in the memory unit, or may be configured to be memorized by an ECU of each of the electricity storage devices.

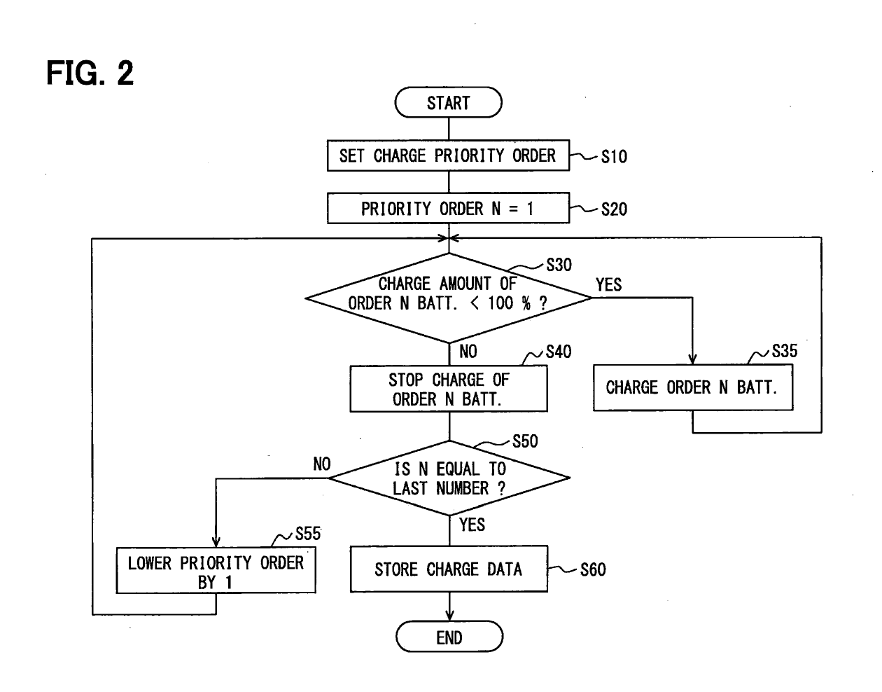

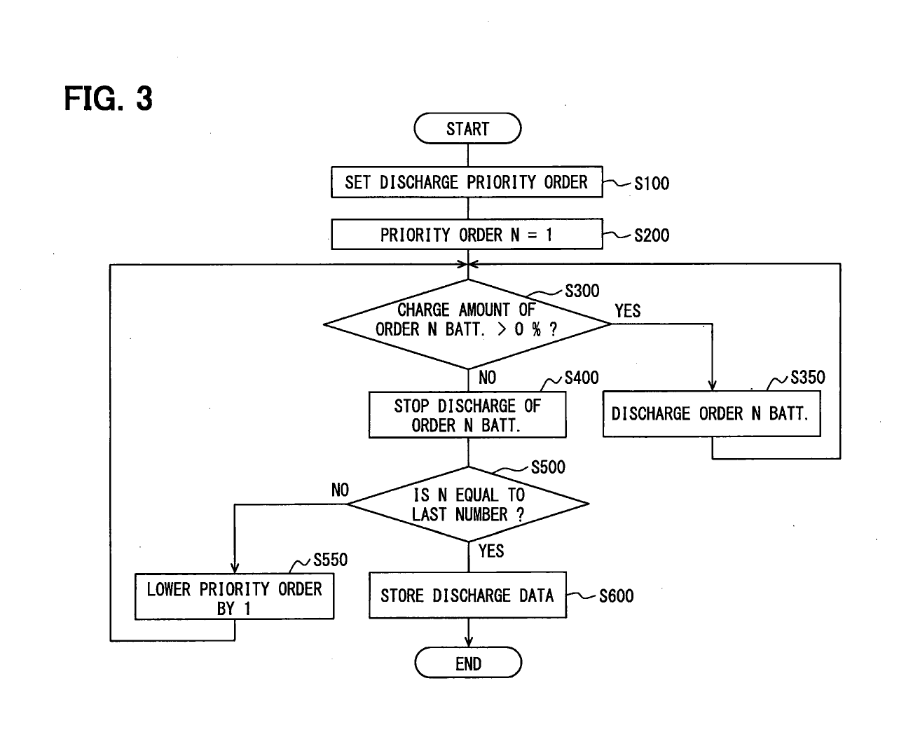

The drive controller performs a control of the discharge operation and the charge operation according to the predetermined arithmetic operation program by using the discharge priority and the charge priority which are determined by the priority determination unit. Specifically, the drive controller performs the charge operation and the discharge operation according to a flowchart in FIG. 2 and FIG. 3 mentioned later. That is, the consolidation ECU 21 controls the charger-discharger 3 according to a predetermined arithmetic operation program, and performs the charge operation and the discharge operation one by one (i.e., charge/discharge electric power to/from one electricity storage device at a time) according to the priority order. In such manner, since one electricity storage device having a comparable rated capacity is charged or discharged at a time, none of the supply power from nor the selling power to the power grid 5 will be drastically changed at the time of charge or discharge.

The photovoltaic power generation apparatus is provided with a photo-voltaic panel 1 containing the solar cells which collect sunlight energy and generate electric power, and a power conditioner 10 (i.e., a photo-voltaic PCS in FIG. 1). The direct-current (DC) electric power which the photo-voltaic panel 1 generates from the sunlight energy is sent to the power conditioner 10. The power conditioner 10 is a power converter which converts the direct current electric power (i.e., a DC power) generated by the photo-voltaic panel 1 efficiently to an alternate-current (AC) electric power. The electric power sent to the power conditioner 10 is converted between the AC power and the DC power, and is further sent to the switch board 6 via the circuit breaker 11.

At a location between the power conditioner 10 and the circuit breaker 11, a power detection device 12 is installed which detects an amount of electric power. The consolidation ECU 21 can obtain a detection signal of the power detection device 12, and can detect an amount of electric power supplied from the photovoltaic power generation apparatus. The switch board 6 receives a supply of the grid power of the power grid 5 from an electric power company, a supply of the generated power from the photovoltaic power generation apparatus, the stored electric power of each of the electricity storage devices, and the like. The electric power sent to the switch board 6 may be supplied to the household appliance load 4, to the charger-discharger 3 or the like. Each of the household appliance loads 4 has a predetermined required amount of electric power that is required for the operation thereof. The switch board 6 supplies the predetermined required amount of electric power to each of the household appliance loads 4.

The power line 60 is an AC power line of a single-phase three-wire system, having one neutral wire and two voltage wires, for example. To such a power line 60, the system power from the power grid 5, the generated power from the photovoltaic power generation apparatus, the stored electric power from each of the electricity storage devices, etc. are supplied via the switch board 6. At a location between the switch board 6 and the power grid 5, a power detection device 50 which detects the amount of electric power flowing therebetween is provided. The consolidation ECU 21 can obtain a detection signal of the power detection device 50, and can detect the supply amount of electric power from the power grid 5 and an upflow electric power (i.e., an amount of the selling power) to the power grid 5. As the upflow electric power, the generated power of the photovoltaic power generation apparatus and the stored electric power of each of the electricity storage devices may be supplied.

The switch board 6 is equipped with, for example, a main circuit breaker and an electric current circuit breaker with a leak detection function which regulates the electric current upper limit value which flows to each of the circuit systems. The household appliance load 4 is connected to the power line 60, and an electric power is supplied to the household appliance load 4 via the power line 60.

A power line 61 connects the switch board 6 and the charger-discharger 3, and is electrically connected to a cable which extends from the charger-discharger 3 to each of the electricity storage devices 2, 2A and 2B. At a location between the switch board 6 and the charger-discharger 3, a power detection device 31 which detects an amount of electric power flowing through the power line 61 is provided. A detection signal of the power detection device 31 is inputted to the consolidation ECU 21.

The charger-discharger 3 receives a supply of electric power via the switch board 6 and a power line 71, i.e., the system power from the power grid 5 and the generated power of the photovoltaic power generation apparatus are supplied thereto. The charger-discharger 3 can charge and discharge electric power to and from each of the electricity storage devices 2 and 2A and 2B by using an internal bidirectional inverter. The charger-discharger 3 is provided with a charge-and-PCS controller, a power supply conversion circuit, a communication board, an AC/DC converter, etc., for example.

When charging each of the electricity storage devices, the bidirectional inverter converts an AC power supplied via a power line 71 to a DC power, and the electricity storage device is charged with the converted DC power. On the other hand, when discharging from each of the electricity storage devices, the bidirectional inverter converts a DC power which is stored in each of the electricity storage devices to an AC power, and discharges it to the switch board 6. That is, the bidirectional inverter is a power converter which converts an AC power to a DC power at the time of charge of the electricity storage device, and converts a DC power to an AC power at the time of discharge of the electricity storage device. The consolidation ECU 21 can control the bidirectional inverter and the switch board 6, and can control the charge to each of the electricity storage devices, the discharge (i.e., the upflow electric power) to the power grid 5, and the discharge to the household appliance load 4.

Next, an example of how to control the electricity storage device when a charge request is sent to the electricity storage device in the charge-discharge system 100 is explained according to FIG. 2. Processing concerning such a control is mainly performed by the consolidation ECU 21.

If the consolidation ECU 21 has a charge request to the electricity storage device, the ECU 21 starts a control according to a flowchart of FIG. 2. For example, when a request signal is input from an operation display device by a user operation, when a charge condition is met for charging the generated power of the photovoltaic power generation apparatus, or when a charge condition is met for charging the system power, it is determined that a charge request occurred.

The charge condition for charging the generated power of the photovoltaic power generation apparatus is considered as satisfied when, for example, (i) the generated power is available, (ii) no power supply is required for the household appliance load 4, (iii) a power selling condition to sell the power grid 5 is not satisfied, and (iv) at least one of the electricity storage devices is in a chargeable state. In this case, the generated power of the photovoltaic power generation apparatus will not be wasted as surplus electric power, but is stored in the electricity storage device, and will be later used effectively at the time of next electric discharge.

The charge condition for charging the system power is considered as satisfied when, for example, (i) no generated power is available, (ii) no power supply is required for the household appliance load 4, (iii) a power buying condition to buy electric power from the power grid 5 is satisfied, and (iv) at least one of the electricity storage devices is in a chargeable state. In this case, by storing in (i.e., by charging to) the electricity storage device, a relatively low cost system power, the cost of using electric power is lowered without experiencing a power shortage when electric power is on demand. When the charge request no longer exists, a charge operation control according to the flowchart of FIG. 2 will be forced to terminate.

If it is determined that the consolidation ECU 21 has a charge request, the process in Step S10 determines/sets a charge priority order. This process determines, for all the electricity storage devices that are subject to the control of the ECU 21, the priority order of charging according to the charge priority determination criteria memorized to the memory unit in advance, for example. Further, the process in Step S10 may determine the priority order of charging based on an arithmetic operation by using information on a degree of use of each of the electricity storage devices and by executing the pre-stored program.

The information on a degree of use of each of the electricity storage devices is about the charge time/hour, the number of charge times, etc. of each of the batteries. According to such information, the progress of degradation of each battery can be recognized. A high charge priority order is given to, for example, a battery which has a low degradation progress degree. That is, the charge priority orders of the multiple electricity storage devices are determined so that no specific device degrades faster than the other devices, i.e., the devices are evenly used and the degradation is paced with each other among all devices. Further, the process in Step S10 may determine the priority order every time the charge request occurs or may determine and update the priority order at predetermined intervals.

Next, in Step S20, the process sets a parameter N of the charge priority order to ‘1’, to start a charge operation of the batteries. Then, in Step S30, the process obtains the battery information such as SOC from the battery having the charge priority order N (i.e., from an order N battery, hereafter: e.g., a first order battery, a second order battery etc.), and determines whether the obtained SOC of the order N battery is smaller than 100%. The determination criterion in Step S30 may be other than 100%, that is, the process in Step S30 may determine whether the obtained SOC is smaller than a predetermined threshold value that is smaller than 100%, for example.

When it is determined that the obtained SOC is smaller than 100% in Step S30, the process in Step S35 performs a charge operation of the electricity storage device of the first priority order. That is, the consolidation ECU 21 switches a relay to an ON state which permits the electric power supply to the first order battery having the first charge priority order, and instructs, to the bidirectional inverter of the charger-discharger 3, a start of charging. The bidirectional inverter converts an AC power to a DC power, and a DC power is supplied to the first order battery, and the charge of the first order battery is performed. Further, in Step S30, the charging of such battery is continued until the SOC of such battery reaches 100% (i.e., until the battery has a full charge).

When it is determined that the SOC is equal to 100% in Step S30, which indicates a full charge of the battery, the process stops the charging to the first order battery (Step S40). Next, in Step S50, the process determines whether the number N is the lowest priority order of all the electricity storage devices currently under control. That is, it is determined whether N is equal to the last number of priority orders (of the currently-available batteries).

Since it is the first cycle of execution of FIG. 2 control process, the number N is equal to 1. Therefore, the process in Step S50 determines that N is not the last number of priority orders, and then in Step S55, the process lowers the priority order by 1, i.e., N is set to 2. Then, after returning to Step S30, the process obtains the battery information such as SOC from the second order battery, and determines whether the SOC concerned is smaller than 100%. When it is determined that the SOC is smaller than 100% in Step S30, the consolidation ECU 21 will perform the charge operation to the electricity storage device of the second priority order in Step S35. Then, after bringing the second order electricity storage device to a full charge, the process in Step S40 stops the charge, and the process in Step S50 determines that the parameter N is not the last number of the priority orders, i.e., branching to NO in Step S50, and then the process in Step S55 lowers the priority order by 1, i.e., setting the number N to 3. Again, returning to Step S30, the process from Step S30 to Step S50 will be repeated for the third order electricity storage device.

Further, if the battery to which the charge has just been stopped has the lowest priority order, i.e., the last number of charge priority, the process in Step S50 branches to YES. In other words, the charge control for all devices is now complete. The process in Step S60 stores charge data for the current charge control in the memory unit, and the charge control is finished. The charge data may be, for example, about the number of charge times, the charge time/hour, the voltage, the electric current, the battery temperature, etc., and may be utilized as information for determining future charge priority orders, for example.

Thus, in the charge control of the charge-discharge system 100, the charge of each of the electricity storage devices is performed one device at a time in a descending charge priority order. Therefore, when charging the system power supplied from the power grid 5, the amount of the supply power from the power grid 5 will not be changed drastically. For example, if the charge is simultaneously performed for two electricity storage devices, the amount of the supply power from the power grid 5 may be doubled, which will not be the case for the present embodiment. Further, in Step S55, after lowering the priority order by 1 to switch to the next-order electricity storage device, the consolidation ECU 21 may further lower the priority order by 1 in case that an abnormality or the like is detected in the switched-to electricity storage device, and then performs the determination in Step S30. Further, the operation display device displays an operation state of the charge control on a display screen.

Next, an example of how to control the electricity storage device when a discharge request is sent to the electricity storage device in the charge-discharge system 100 is explained according to FIG. 3. Processing concerning such a control is mainly performed by the consolidation ECU 21.

If the consolidation ECU 21 has a discharge request to the electricity storage device, the ECU 21 starts a control according to a flowchart of FIG. 3. For example, when a request signal is input from the operation display device by a user operation, when a discharge condition is met for discharging the electric power to the household appliance load 4, or when a power selling condition is met for selling the electric power to the power system (i.e., to the power grid 5), it is determined that a discharge request occurred.

The discharge condition for discharging to the household appliance load 4 is considered as satisfied when, for example, (i) a power supply is required for the household appliance load 4, (ii) no generated power is available from the photovoltaic power generation apparatus, and (iii) at least one of the electricity storage devices is in a dischargeable state.

The power selling condition for selling the electric power to the power system is considered as satisfied when, for example, (i) no power supply is required for the household appliance load 4, (ii) no generated power is available for selling to the power system (i.e., to the power grid 5), and (iii) at least one of the electricity storage devices is in a dischargeable state. In this case, by selling the stored electric power in -the electricity storage device to the power system (i.e., to the power grid 5), a total cost of electric power has an economic benefit. When the discharge request no longer exists, a discharge operation control according to the flowchart of FIG. 3 will be forced to terminate.

If it is determined that the consolidation ECU 21 has a discharge request, the process in Step S100 determines/sets a discharge priority order. This process determines, for all the electricity storage devices that are subject to the control of the ECU 21, the priority order of discharging according to the discharge priority determination criteria memorized to the memory unit in advance, for example. Further, the process in Step S10 may determine the priority order of discharging based on an arithmetic operation by using information on a degree of use of each of the electricity storage devices and by executing the pre-stored program.

The information on a degree of use of each of the electricity storage devices is about the discharge time/hour, the number of discharge times, etc. of each of the batteries. According to such information, the progress of degradation of each battery can be recognized. A high discharge priority order is given to, for example, a battery which has a low degradation progress degree. That is, the discharge priority orders of the multiple electricity storage devices are determined so that no specific device degrades faster than the other devices, i.e., the devices are evenly used and the degradation is paced with each other among all devices. Further, the process in Step S100 may determine the priority order every time the discharge request occurs or may determine and update the priority order at predetermined intervals.

Next, in Step S200, the process sets a parameter N of the discharge priority order to ‘1’, to start a discharge operation of the batteries. Then, in Step S300, the process obtains the battery information such as SOC from the battery having the discharge priority order N (i.e., from an order N battery, hereafter: e.g., a first order battery, a second order battery etc.), and determines whether the obtained SOC of the order N battery is greater than 0%. The determination criterion in Step S300 may be other than 0%, that is, the process in Step S300 may determine whether the obtained SOC is greater than a predetermined threshold value that is greater than 0%, for example.

When it is determined that the obtained SOC is greater than 0% in Step S300, the process in Step S350 performs a discharge operation of the electricity storage device of the first priority order. That is, the consolidation ECU 21 switches a relay to an ON state which permits the electric power discharge from the first order battery having the first discharge priority order, and instructs, to the bidirectional inverter of the charger-discharger 3, a start of discharging. The bidirectional inverter converts a DC power of the first order battery to an AC power, and an AC electric power is discharged therefrom. Further, in Step S300, the discharging of such battery is continued until the SOC of such battery falls down to 0%.

When it is determined that the SOC is equal to 0% in Step S300, the process stops the discharging from the first order battery (Step S400). Next, in Step S500, the process determines whether the number N is the lowest priority order of all the electricity storage devices currently under control. That is, it is determined whether N is equal to the last number of priority orders (of the currently-available batteries).

Since it is the first cycle of execution of FIG. 3 control process, the number N is equal to 1. Therefore, the process in Step S500 determines that N is not the last number of priority orders (S500:NO), and then in Step S550, the process lowers the priority order by 1, i.e., N is set to 2. Then, after returning to Step S300, the process obtains the battery information such as SOC from the second order battery, and determines whether the SOC concerned is greater than 0%. When it is determined that the SOC is greater than 0% in Step S300, the consolidation ECU 21 will perform the discharge operation to the electricity storage device of the second priority order in Step S350. Then, after bringing the stored electric power of the second order electricity storage device to a zero charge, i.e., to a power shortage state, the process in Step S400 stops the discharge, and the process in Step S500 determines that the parameter N is not the last number of the priority orders, i.e., branching to NO in Step S500, and then the process in Step S550 lowers the priority order by 1, i.e., setting the number N to 3. Again, returning to Step S300, the process from Step S300 to Step S500 will be repeated for the third order electricity storage device.

Further, if the battery to which the charge has just been stopped has the lowest priority order, i.e., the last number of discharge priority, the process in Step S500 branches to YES. In other words, the discharge control for all devices is now complete. The process in Step S600 stores discharge data for the current discharge control in the memory unit, and the discharge control is finished. The discharge data may be, for example, about the number of discharge times, the discharge time/hour, the voltage, the electric current, the battery temperature, etc., and may be utilized as information for determining future discharge priority orders, for example.

Thus, in the discharge control of the charge-discharge system 100, the discharge of each of the multiple electricity storage devices is performed one device at a time in a descending discharge priority order. Therefore, when discharging the electric power from the multiple electricity storage devices, the amount of the discharge electric power from the multiple electricity storage devices will not be changed drastically. For example, if the discharge is simultaneously performed from two electricity storage devices, the amount of the discharge electric power from the two electricity storage devices may be doubled in comparison to the one-by-one discharge scheme, which will not be the case for the present embodiment. Further, in Step S550, after lowering the priority order by 1 to switch to the next electricity storage device, the consolidation ECU 21 may further lower the priority order by 1 in case that an abnormality or the like is detected in the switched-to electricity storage device, and then performs the determination in Step S300. Further, the operation display device displays an operation state of the discharge control on a display screen.

The operation effect achieved by the first embodiment of the present disclosure is described below.

The consolidation ECU 21 which is a charge-discharge controller of the first embodiment controls the charge operation which charges the electric power supplied from the power grid 5 to the electricity storage device and the discharge operation which discharges the stored electric power from the electricity storage device, i.e., to/from the multiple electricity storage devices 2 and 2A and 2B each of which has comparable rated capacity with each other. The consolidation ECU 21 drives one device at a time according to a priority order, without simultaneously driving multiple devices, when performing the charge operation and the discharge operation of the multiple electricity storage devices 2 and 2A and 2B.

According to such a control, when charging or discharging of the multiple electricity storage devices 2 and 2A and 2B is performed, according to a priority order, the consolidation ECU 21 drives the electricity storage devices one by one at a time, without driving the multiple electricity storage devices simultaneously (no two or more devices operated/driven simultaneously). Further, each of the electricity storage devices 2 and 2A and 2B has a comparable rated capacity (i.e., substantially the same capacity), thereby not causing a drastic fluctuation of the charge/discharge electric power in the supply power from the power grid 5 or in the selling power to the power grid 5 when they are driven, i.e., when charged or discharged. Therefore, in case that a charge-discharge system has multiple electricity storage devices having respectively different instantaneous output capacities, a system-determined excessive electric current protection value can effectively protect all those multiple electricity storage devices. That is, each of the multiple electricity storage devices in the system is securely protected from suffering from the excessive electric current.

Further, the electricity storage device is always driven as “one device” at a time, i.e., the device demands only one device capacity to the power grid 5, the power grid 5 considers the electricity storage device under control of the charge-discharge controller as “one device.” Furthermore, the user can register the subject system as “one device” to the electric power company for the contract of system/grid connection. Furthermore, it is not necessary for the user to prepare the system with different capacity devices.

The charge-discharge system 100 of the first embodiment includes a charge-discharge controller (i.e., the consolidation ECU 21) and a plurality of electricity storage devices 2, 2A, 2B having a substantially the same level (i.e., equal) of rated capacity that respectively charge a supply power from the power grid 5 and respectively discharge a stored power therefrom, and when the charge-discharge controller controls a charge operation and a discharge operation of the plurality of electricity storage devices 2, 2A, 2B, the charge-discharge controller performs the charge operation or the discharge operation exclusively for one device at a time according to a priority order of each of the plurality of electricity storage devices without performing simultaneous drive of more than one electricity storage device.

According to such a configuration, when charging or discharging the multiple electricity storage devices 2 and 2A and 2B all of which have comparable rated capacity, the charge-discharge system 100 realized a control of multiple device, which does not simultaneously drive two or more storage devices at one time, but drives only one storage device according to a priority order of each of the devices 2, 2A, 2B.

In such a control scheme, the capacity/amount of the electric power (i) for the charging of the multiple electricity storage devices 2, 2A, 2B by a supply power from the power grid 5 and (ii) for the discharging of such electric power to an outside of the system 100 is always within one device capacity, which does not drastically fluctuate. Further, by such a control scheme, each of the multiple electricity storage devices in the system 100 is securely protected from the excessive electric current, which is a novel and non-obvious solution of the problem described in the background section.

### Second Embodiment

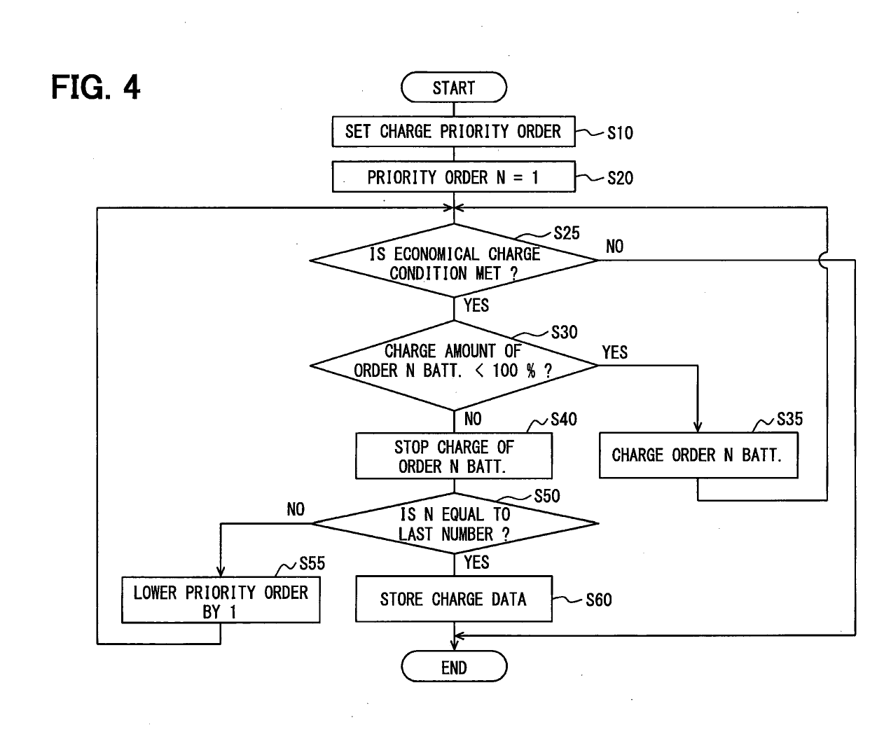

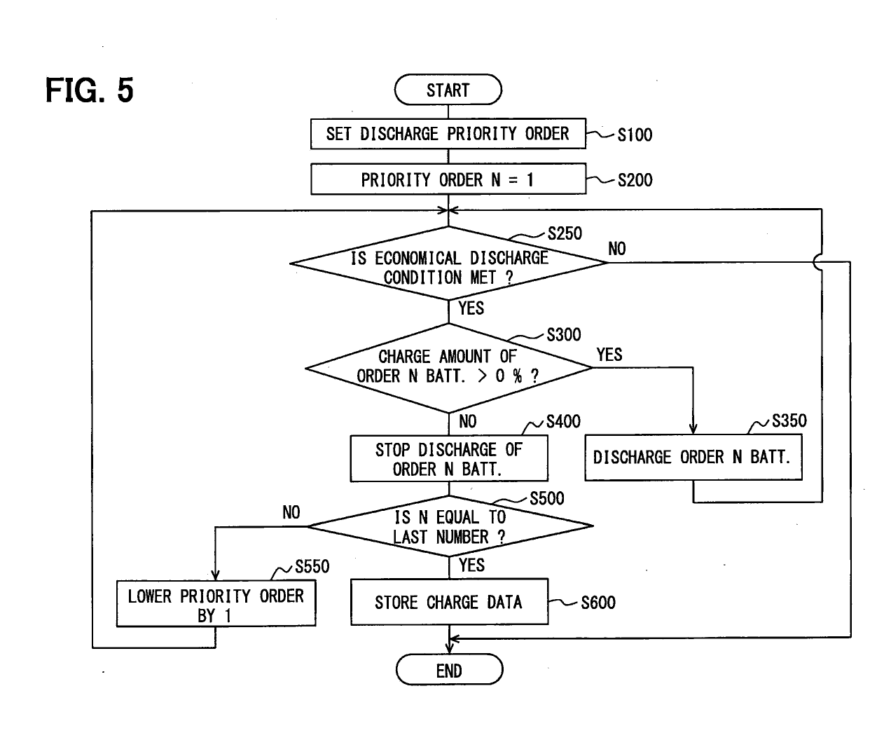

The second embodiment of the present disclosure is about a different control for handling the charge request and the discharge request, which is described with reference to FIGS. 4 and 5. In the second embodiment, the configuration as well as the operation and the effects of the charge-discharge system 100 are the same as the first embodiment, and the steps of the flowcharts in FIGS. 4 and 5 having the same numerals as the first embodiment are the same steps as the first embodiment.

An example of a control when a charge request occurs is explained according to the flowchart in FIG. 4. This flowchart is different from the one in FIG. 2 regarding the first embodiment in that a determination process in Step S25 is performed after Step S20. Hereafter, only a different portion from the control of the first embodiment is described.

The consolidation ECU 21 determines whether an economically beneficial charge condition is satisfied in Step S25 after Step S20 in which a process sets the first charge priority to the priority order number/parameter N, which has been determined in Step S10. In this determination process, it is determined whether there is any economic benefit when a charge is performed for the electricity storage device of the order N priority. That is, in other words, if the cost of charge is determined as an allowable level in the light of a preset determination criterion, the process proceeds to Step S30, and determines whether the SOC indicates that the electricity storage device is chargeable. On the other hand, if it is determined that the cost is not an economically allowable level, the control will be finished, without carrying out the charge.

When performing the charge by using the supply power from the power grid 5, the economically beneficial charge condition is determined as satisfied if, for example, a buying price of per-unit power of the system/grid power is cheaper than a preset standard buying price, and, when the condition is determined as satisfied, the charge is either performed or continued.

On the other hand, if a buying price of per-unit power of the system/grid power is not cheaper than a preset standard buying price, the economically beneficial charge condition is determined as NOT satisfied, and the charge is stopped (i.e., partially performed).

Further, for example, when the generated power from the photovoltaic power generation apparatus is available, the economically beneficial charge condition is determined as satisfied, the charge is either performed or continued. In addition, a preset standard buying price may be periodically/non-periodically updated based on an external information that is obtained from an outside of the charge-discharge system 100 regarding the cost of the electric power, and is memorized in the memory unit.

Thus, in the charge control of the second embodiment, when a charge request occurs, a determination whether to charge or not will be made from a viewpoint of economic efficiency, and, depending on the determination result, the charge will not be performed even for the electricity storage device which has a SOC indicating that the device is chargeable.

According to the charge control of the second embodiment, in the charging using the supply power from the power grid 5, according to the buying price of the system power, the number of the electricity storage devices to charge and/or an amount of electric power for charging may be limited, for example. That is, the charge is performed only for the high priority electricity storage device(s) according to the priority orders within the limits of the restricted amount of the available electric power. Therefore, if the charging of the next priority order electricity storage device is not performable within the limits of the restricted amount, the next device will not be charged and the charge is stopped.

Further, an example of a control when a discharge request occurs is explained according to the flowchart in FIG. 5. This flowchart is different from the one in FIG. 3 regarding the first embodiment in that a determination process in Step S250 is performed after Step S200. Hereafter, only a different portion from the control of the first embodiment is described.

The consolidation ECU 21 determines whether an economically beneficial charge condition is satisfied in Step S250 after Step S200 in which a process sets the first charge priority to the priority order number/parameter N, which has been determined in Step S100. In this determination process, it is determined whether there is any economic benefit when a discharge is performed from the electricity storage device of the order N priority. That is, in other words, if the profit of discharge is determined as an allowable level in the light of a preset determination criterion, the process proceeds to Step S300, and determines whether the SOC indicates that the electricity storage device is dischargeable. On the other hand, if it is determined that the profit is not an economically allowable level, the control will be finished, without carrying out the discharge.

When performing the discharge for selling the electric power to the power grid 5, the economically beneficial charge condition is determined as satisfied if, for example, a selling price of per-unit power to the system/grid (i.e., to the power company) is higher than a preset standard selling price, and, when the condition is determined as satisfied, the discharge is either performed or continued.

On the other hand, if a selling price of per-unit power to the system/grid (i.e., to the power company) is not higher than a preset standard selling price, the economically beneficial charge condition is determined as NOT satisfied, and the discharge is stopped, and the stored electric power in the electricity storage device is left untouched (i.e., partially performed). In addition, a preset standard selling price may be periodically/non-periodically updated based on an external information that is obtained from an outside of the charge-discharge system 100 regarding the profit of the selling of the electric power, and is memorized in the memory unit.

Thus, in the discharge control of the second embodiment, when a discharge request occurs, a determination whether to discharge or not will be made from a viewpoint of economic efficiency, and, depending on the determination result, the discharge will not be performed from the electricity storage device whose SOC indicates that the device is dischargeable.

According to the discharge control of the second embodiment, in the discharging for selling the electric power to the power grid 5, according to the selling price of the per-unit electric power, the number of the electricity storage devices to discharge and/or an amount of electric power for discharging may be limited, for example. That is, the discharge is performed only from the high priority electricity storage device(s) according to the priority orders within the limits of the restricted amount of the dischargeable electric power. Therefore, if the discharging from the next priority order electricity storage device is not performable within the limits of the restricted amount, the next device will not be discharged and the discharge is stopped.

The operation effect achieved by the second embodiment of the present disclosure is described below.

The charge-discharge controller (i.e., the consolidation ECU 21) performs the charge for one device at a time according to the charge priority order in a descending manner, when a request for a charge operation of the multiple electricity storage devices 2, 2A, 2B occurs and the economically beneficial charge condition regarding the charge cost is satisfied (Step S25, S30). Further, the consolidation ECU 21 ends the charge operation even when a chargeable electricity storage device is left uncharged, if the economically beneficial charge condition is not satisfied (Step S25).

According to such a configuration, while the charge operation of the electricity storage device is realized/enabled/performable without drastically fluctuating/changing the supply power from the power grid 5, the economical charge control which takes into consideration the cost of electric power is performed.

Further, the charge-discharge controller performs discharge from one device at a time according to the discharge priority order in a descending manner, when a request for a discharge operation of the multiple electricity storage devices 2, 2A, 2B occurs and the economically beneficial discharge condition regarding the electric power cost (i.e., predetermined charge/discharge cost condition) of the discharge is satisfied (Step S250, S300). Further, the consolidation ECU 21 ends the discharge operation, even when a dischargeable electricity storage device is left un-discharged, if the economically beneficial discharge condition is not satisfied (Step S250).

According to such a configuration, while the discharge operation of the electricity storage device is realized without drastically fluctuating/changing the discharge electric power to the power grid 5 or to an external device, the economically beneficial discharge control which takes into consideration the electric power cost is performed.

### Other Embodiments

Although the present disclosure has been fully described in connection with preferred embodiment thereof with reference to the accompanying drawings, it is to be noted that various changes and modifications will become apparent to those skilled in the art.

The configurations of the above-mentioned embodiments are only examples, and the scope of the present disclosure is not limited to those configurations. The scope of the present disclosure thus includes the recitation in the claimed scope as well as the equivalents thereof.

Although, in the above embodiments, the photovoltaic power generation device is described as a power generator using the energy of nature, the power generator concerned is not necessarily limited to such device. That is, the power generator may also be a wind turbine generator, a hydraulic power generator, a tidal power generator, or the like, for example.

Although, in the above embodiments, a LAN communication, a PLC communication, a CPLT communication, etc. are used as the communication method for transmitting information between each of the components, the communication method is not necessarily be limited to such methods. That is, other communication methods other than the above may also be adoptable. Further, the communication method may be a wired communication or may also be a wireless communication.

Although, in the above-mentioned embodiment, the building in which the household appliance load 4 is installed is a residence, the building other than the residence, such as a commercial facility, a public facility, a factory, a warehouse, etc., may also be a place for installing the household appliance load 4.

Such changes, modifications, and summarized scheme are to be understood as being within the scope of the present disclosure as defined by appended claims.

What is claimed is:

1. A charge-discharge controller comprising:
a control section controlling a charge operation of a plurality of storage batteries having equal rated capacities which charges electric power from a power grid to the plurality of storage batteries, and a discharge operation of the plurality of storage batteries which discharges electric power stored in the plurality of storage batteries, wherein
the control section performs the charge operation or the discharge operation on only one of the plurality of storage batteries at a time, according to a priority order of the plurality of storage batteries, without performing a charge operation or a discharge operation on more than one of the plurality of storage batteries simultaneously.

2. The charge-discharge controller of claim 1, wherein
in case that the charge operation of the plurality of storage batteries is requested,
when an economically beneficial charge condition regarding a predetermined charge cost condition that is required for charging electric power is satisfied, the charge operation of the plurality of storage batteries is performed on only one of the plurality of storage batteries at a time, according to the priority order in a descending manner, and
when the economically beneficial charge condition regarding the predetermined charge cost condition is not satisfied, the charge operation is partially performed.

3. The charge-discharge controller of claim 2, wherein
the charge operation is partially performed even when at least one of the plurality of storage batteries remains to be charged.

4. The charge-discharge controller of claim 1, wherein
in case that the discharge operation of the plurality of storage batteries is requested,
when an economically beneficial discharge condition regarding a predetermined discharge cost condition of discharging electric power is satisfied, the discharge operation of the plurality of storage batteries is performed on only one of the plurality of storage batteries at a time, according to the priority order in a descending manner, and
when the economically beneficial discharge condition regarding the predetermined discharge cost condition is not satisfied, the discharge operation is partially performed.

5. The charge-discharge controller of claim 3, wherein
the discharge operation is partially performed even when at least one of the plurality of storage batteries remains to be discharged.

6. A charge-discharge system comprising:
a plurality of storage batteries having equal rated capacities to charge electric power from and to discharge electric power to a power grid; and
a charge-discharge controller controlling a charge operation of the plurality of storage batteries which charges electric power from the power grid to the plurality of storage batteries, and a discharge operation of the plurality of storage batteries that discharges electric power stored in the plurality of storage batteries, wherein
the controller performs the charge operation or the discharge operation on only one of the plurality of storage batteries at a time, according to a priority order of the plurality of storage batteries, without performing a charge operation or a discharge operation on more than one of the plurality of storage batteries simultaneously.

7. A method for controlling charge-discharge to a plurality of storage batteries having equal rated capacities, the method comprising:
controlling a charge operation of the plurality of storage batteries which charges electric power from a power grid to the plurality of storage batteries, and a discharge operation of the plurality of storage batteries which discharges electric power stored in the plurality of storage batteries; and
performing the charge operation or the discharge operation on only one of the plurality of storage batteries at a time, according to a priority order of the plurality of storage batteries, without performing a charge operation or a discharge operation on more than one of the plurality of storage batteries simultaneously.

8. The method for controlling charge-discharge of claim 7, wherein
in case that the charge operation of the plurality of storage batteries is requested,
when an economically beneficial charge condition regarding a predetermined charge cost condition that is required for charging electric power is satisfied, performing the charge operation occurs on only one of the plurality of storage batteries at a time, according to the priority order in a descending manner, and
when the economically beneficial charge condition regarding the predetermined charge cost condition is not satisfied, performing the charge operation partially occurs even when at least one of the plurality of storage batteries remains to be charged.

9. The method for controlling charge-discharge of claim 7, wherein
in case that the discharge operation of the plurality of storage batteries is requested,
when an economically beneficial discharge condition regarding a predetermined discharge cost condition of discharging electric power is satisfied, performing the discharge operation of the plurality of storage batteries occurs on only one of the plurality of storage batteries at a time, according to the priority order in a descending manner, and
when the economically beneficial discharge condition regarding the predetermined discharge cost condition is not satisfied, performing the discharge operation partially occurs even when at least one of the plurality of storage batteries remains to be discharged.
